(19) United States
(12) Patent Application Publication
(10) Pub. No.: US 2014/0245204 A1
(43) Pub. Date: Aug. 28, 2014

(54) SYSTEM AND METHOD FOR COLLECTING AND REPRESENTING FIELD DATA IN DISASTER AFFECTED AREAS

(71) Applicant: Donan Engineering Co., Inc., Louisville, KY (US)

(72) Inventors: Duane Michael Battcher, Prospect, KY (US); James Lyle Donan, Anchorage, KY (US); Russell A. Zeckner, Louisville, KY (US); Leslie Noel, Louisville, KY (US)

(73) Assignee: Donan Engineering Co., Inc., Louisville, KY (US)

(21) Appl. No.: 14/192,216

(22) Filed: Feb. 27, 2014

Related U.S. Application Data
(63) Continuation of application No. 13/779,865, filed on Feb. 28, 2013.

(51) Int. Cl. G06F 3/0484

(52) U.S. Cl. CPC G06F 3/04842
USPC 715/765

(57) ABSTRACT

Methods and apparatus are disclosed that include the actions of identifying a target geographic area affected by a disaster event, and identifying event characteristics; providing a database with an initial attribute of the target area; obtaining field data related to the disaster event; updating the database with the field data; generating an augmented attribute of the target area based on a synthesis of the field data in the database; storing a representation of the augmented attribute. The representation may be a visual representation, including an augmented map of the target geographic area based on the event characteristics. The initial attribute may include an initial map of the target geographic area. The initial attribute of the target geographic area may be obtained from a weather data system or from a social media platform. Other embodiments may include corresponding systems, apparatus, and computer program products.

### CROSS REFERENCE TO RELATED APPLICATIONS AND CLAIM TO PRIORITY

This application is a continuation of, and claims priority to and benefit under 35 U.S.C. §120, the prior-filed and co-pending U.S. non-provisional application Ser. No. 13/779,865 filed on Feb. 28, 2013, entitled “System and method for collecting and representing field data in disaster affected areas,” the disclosure of which is incorporated by reference herein in its entirety.

### STATEMENT REGARDING FEDERALLY SPONSORED RESEARCH

None.

### REFERENCE TO SEQUENTIAL LISTING, ETC.

None.

### BACKGROUND

Present embodiments are related to a system and method for gathering and presenting information pertaining to weather related event and correlating it to available data from weather reporting systems.

Storms cause physical damage to various properties. In order to efficiently validate and process property damage claims, insurance companies, state and federal agencies, and/or other organizations, need to verify both the geographical boundary of the affected area, and the type and extent of damage to individual properties within the area. The volume of post event claims is typically high. Therefore, it is desirable to have a system and method for collecting and representing field data in a disaster affected area in order to more easily verify the affected geographic area and provide details regarding the extent of damage within that area so that users, such as insurance companies, can reduce the strain on their financial and human resources.

### SUMMARY

The specification describes a system and method relating to information gathering of event characteristics pertaining to weather related events and correlating these to available data from weather reporting systems.

In general, one aspect of the technology described can be embodied in methods that include identifying a target geographic area potentially affected by a disaster event, and identifying event characteristics. The method further includes providing a database with at least one initial attribute of the target area. The method further includes communicating with at least one source to obtain field data related to the disaster event, and updating the database with the field data. The method further includes generating at least one augmented attribute of the target area based on a synthesis of the field data in the database. A representation of the at least one augmented attribute is then stored.

In some implementations, the representation of the augmented attribute may be a visual representation, and in some implementations, the visual representation may include a map of the target geographic area. In some implementations, the at least one initial attribute may include an initial map of the target geographic area. The visual representation may include an augmented map of the target geographic area based on the event characteristics. In some implementations, the at least one target geographic area may be obtained from a weather data system. The weather data system may include one or more of a doppler radar weather system, pulse-doppler radar weather system, and a weather data provider vendor. In some implementations, the at least one target geographic area may be obtained from a social media platform.

The disaster event may be a weather-related event including a thunderstorm, tornado, snowstorm, hailstorm, lightning, drought, or fire. The disaster event may further be a hailstorm and the event characteristics may include factors such as the average size of the hail, the affected geographical area, the time length of the storm, the typical size of hail impact, the damage to property, or the wind velocities. The disaster event may be a natural disaster event including an earthquake, tsunami, flood, or volcano.

The field data may include data from field personnel deployed in the target geographic area or data captured through one or more social media platforms. The at least one source providing the field data may be a field personnel. Communication may include communication using a mobile device.

In some implementations, the database may be updated with field data including automated receipt and update of data, including data from field deployed remote sensors, cartographic cameras, aerial reconnaissance systems, or satellite images. In yet other implementations, the updating of the database with the field data may include iterative updating of the database at pre-determined time intervals.

These and additional embodiments can include a system and method for collecting and representing event characteristics for one or more of the following disaster events: a weather related event (e.g., thunderstorm, tornado, snowstorm, hailstorm, lightning, drought, fires), a natural disaster event (e.g., earthquake, tsunami, floods, volcanoes), and/or a human induced event (e.g., wars, fires).

Event characteristics may include identifying data from one or more weather data systems, feeds from social media like Facebook, Twitter, feeds from television signals, photographs of the damage, sampling of field data pertaining to the size, spread and magnitude of impact characteristics, geo-position markers for event impact areas, real-time reading of humidity, pressure, temperature, wind velocity, water level, etc. Field deployment can include manual deployment of personnel to document event characteristics, or field data collection through remote techniques, including aerial photographs, use of cartographic cameras, and/or satellite images. Event characteristics may be documented using preset data forms. The collection of field data may be user-interfaced via a specialized web page or a mobile application to provide efficient access to personnel deployed in the field. The system may also be configured to synchronize other field deployment techniques and/or mobile devices. The system itself may be hosted by one or more servers, including a cloud server. Specified post-event time intervals to retrieve and update data may vary according to the type of event, the event characteristics, or accessibility to the event area.

In some implementations, the representation of the one or more augmented attributes may include representation on a display device. In some implementations, this representation may be in the form of a real-time mapping of the affected area. In some implementations, such a map may be an interactive display with icons and menus that are capable of providing further data, and/or provide access to location specific images, audio, video, and related documents. The specialized maps displaying the field data may be interactive, offering different levels of detail, 2-D, 3-D or satellite views, populated with positional icons with field data, and/or contour mapping. One or more augmented attributes from the database may be sent to vendors such as weather systems, mapping services, or television networks. In some implementations the one or more augmented attributes may be sent to the vendor in electronic format. For example, the augmented database may be sent as an electronic database to a vendor for the vendor to thereby augment or create its own weather database. Additionally, in some implementations the augmented database can be sent to vendors whereby the vendors augment or create a display, including weather maps. Further, one or more augmented attributes from the database may also be sent as feeds into social networking platforms. Additionally, the maps may be drawings or simply a written description of the affected geographic area. These maps may be available to end-users in either electronic form, for example by way of email, specialized web pages, or mobile applications, or by written or typed document.

Other implementations may include a disaster identification and management system comprising a communication and monitoring environment in optional combination with one or more weather data systems, wherein the communication and monitoring environment comprises communication infrastructure capable of data exchange from and between central command or distributed information resources and a plurality of client devices in the field. Yet another implementation may include a non-transitory computer readable storage medium storing computer instructions executable by a processor to perform the various methods described herein.

In general, one aspect of the technology described can be embodied in methods that include retrieving and updating real-time, on-site data pertaining to event characteristics. This may be accomplished via field deployment. This data is then uploaded to the system and correlated to and synthesized with available metrics from weather reporting systems to create specialized maps. The retrieval and update of data is achieved over specified post-event time intervals, as needed, thus allowing the system to refine and update the specialized maps.

Another aspect of the technology disclosed is an implementation of a system to realize one or more of the following advantages. The system can learn from past field and weather observations to suggest specific data retrieval by field personnel.

The details of one or more embodiments of the technology disclosed in this specification are set forth in the accompanying drawings and the description below. Additional features, aspects, and advantages of the technology disclosed will become apparent from the description, the drawings and the claims.

### BRIEF DESCRIPTION OF THE DRAWINGS

FIG. 1 illustrates a block diagram of an example communication and monitoring process environment in optional combination with one or more weather data systems.

FIG. 2 illustrates a block diagram of an example central command module within the communication and monitoring process environment.

FIG. 3 illustrates a flow diagram of an example process that includes a feed from a weather data system.

FIG. 4 illustrates a block diagram of an example post event periodic retrieval and update process.

FIG. 5 illustrates a block diagram of an example communication and monitoring process environment.

FIG. 6 illustrates a flow diagram of an example process that does not include a feed from a weather data system.

FIG. 7A illustrates an example of an initial attribute, specifically a map based on a feed from a weather data system indicating a hailstorm in a geographic area.

FIG. 7B illustrates an example of an initial attribute, specifically an initial map representing projected hailstone sizes.

FIG. 7C illustrates an example of an initial attribute, specifically an initial map representing a data collection grid to capture event characteristics.

FIG. 7D illustrates an example of a representation of an augmented attribute, specifically an augmented map representing actual hailstone sizes based upon a synthesis of field data.

### DETAILED DESCRIPTION

The embodiments herein are generally directed to a system and method for integrating ground-level field observations from a disaster hit area with disaster related data obtained from an independent source and representing this information on an augmented map. The map itself may be tagged, annotated and/or accompanied by menus, icons, photographs, text, and audio, related to the disaster event.

In general, one aspect of the technology described can be embodied in methods that include identifying a target geographic area potentially affected by a disaster event, and identifying event characteristics. The method further includes providing a database with at least one initial attribute of the target area. The method further includes communicating with at least one source to obtain field data related to the disaster event, and updating the database with the field data. The method further includes generating at least one augmented attribute of the target area based on a synthesis of the field data in the database. A representation of the at least one augmented attribute is then stored.

Generally speaking, one or more systems may be configured to receive signals from an independent weather data system about a current, imminent or potential disaster and identify a target geographic area based on these signals. Additional information and data about event characteristics may be received from one or more clients and vendors within the target area. A preliminary map of the target area may then be formed. The system then receives field data related to the disaster event from a plurality of sources within the target geographic area. As such localized and ground-level field data is received, the system may be generally configured to populate a database and outlay this updated information onto the preliminary map of the target area. As more data is received, from the field and optionally from independent weather data systems, the preliminary map is filled in with augmented details. A preliminary map of a target area morphs into an augmented map representing the scope and dimension of the disaster. The extent of physical damage to property may then be directly observed from the collected field data and/or inferred from available statistical and technical data about the extent and type of damage from a disaster of given scope and dimension. This augmented map is then provided to clients such as insurance companies who may, in a particular instance, determine the validity of an individual insurance claim based on the physical location of the subject property within the augmented map. For instance, insurance companies may validate all claims from a particular area falling within an identified region on the augmented map, where the region is identified because the texturing suggests a high probability that damage was incurred by subject property due to the disaster related event. Likewise, the insurance company may further investigate those claims from properties that are outside this identified region. Finally, this frees up the insurance companies' limited resources to pursue the legitimacy of claims from properties that lie in an ambiguous region within the augmented area. The details in the augmented map may further provide collateral indicators to determine if a claim was a result of a disaster event or another cause.

These and other particular embodiments will be described in more detail with the help of figures.

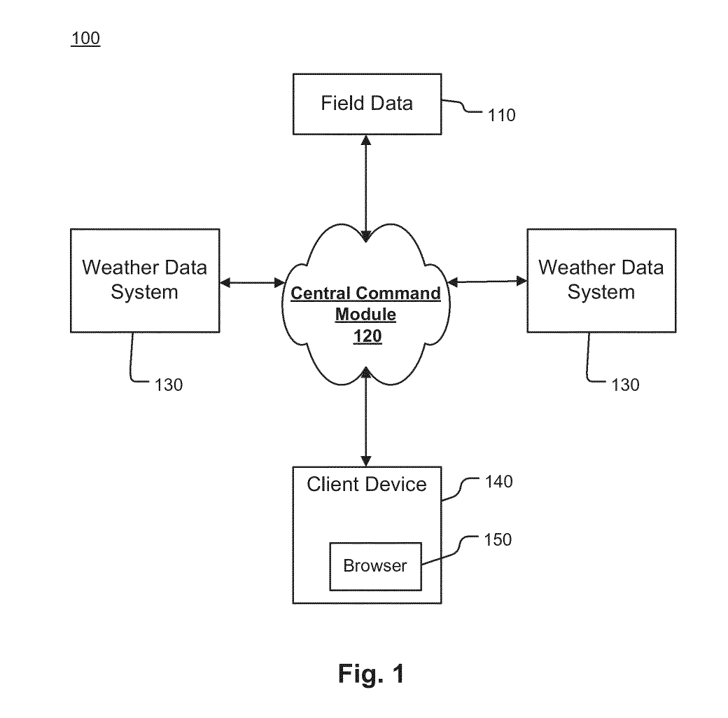

FIG. 1 illustrates a block diagram of an example communication and monitoring process environment 100 in optional combination with one or more weather data systems 130. The process environment 100 includes input of field data 110, and one or more client devices 140. The process environment 100 also includes a central command 120 that allows for communication between various components of the process environment 100.

During operation, field data may be uploaded into the system both manually or automatically. Field deployment can include manual deployment of personnel to document event characteristics, or field data collection through remote techniques, including aerial photographs, use of cartographic cameras, and/or satellite images. The field data 110 collected may be uploaded into the system either automatically or manually through an appropriate user interface. The user driven field data entry could be done in one of many embodiments, including a menu and icon driven approach to enable field personnel to provide reports on incidents and disaster, including classifying the type and scale of disaster, assessing victims and/or casualties, estimating the extent and type of physical damage, uploading photos, videos, audio, text, and other documents, and making recommendations to prioritize the response. In some implementations, the menu and icon driven approach may also be enhanced to provide menus and icons of a generic nature, and also those customized for a particular type of disaster. In some other implementations, the menus and icons may be presented in an interactive manner wherein a particular input into a field data value prompts a further enquiry from the system. In some implementations, the field personnel may be allowed to create data entry fields to enter specific kinds of data. In all such intelligent implementations, the systems may generate a field for data entry based on a learning model from previous field reports. Various implementations of data entry methods could include mobile applications on mobile devices.

Disaster related information may also be received through one or more weather data systems 130. In some implementations, the feeds may be received from social media platforms, television stations, or feedback from clients, vendors, personnel, or other individuals on the ground that may be monitoring the weather. These may include feeds pertaining to meteorological data indicative of a weather phenomenon. In particular, the weather data system 130 could be received from a source such as NEXRAD weather data provided by the National Weather Service. Such data may also be received directly from a real-time weather source such as a doppler or pulse-doppler weather data system managed by a television or cable network. Such data may also be received from a single or multiple weather data provider vendors. Many weather display systems are configured to communicate and message real-time with a communication and monitoring process environment 100 as disclosed herein.

The central command 120 includes memory for storage of data and software applications, a processor for accessing data and executing applications, and components that facilitate communication over the network in the process environment 100. When weather data from a weather data system 130 is provided to the central command 120, it may map the data onto a weather map and identify a potential geographic area that has been affected. Some weather data systems 130 may already be an initial attribute in the form of a map. In some implementations, once a potential geographic area is identified, the central command 120 may send out signals to field agents and remote sensing devices near the affected area to alert them to the possibility of identifying and uploading field data. In some other implementations, the central command 120 may send signals to field agents and remote sensing devices near the affected area requesting specific data. Such a request may be based on past responses to a disaster of a similar nature. Such communication may take place over one or more mobile devices.

The field data 110 and the data from one or more weather data systems are then processed. The initial attributes are modified to generate one or more augmented attributes. In some implementations, the representation of the one or more augmented attributes may include representation on a display device. In some implementations, this representation may be in the form of a real-time mapping of the affected area. In some implementations, such a map may be an interactive display with icons and menus that are capable of providing further data, and/or provide access to location specific images, audio, video, and related documents. Once a visual display is ready, it is provided to a variety of clients on a client device 140. Field or client output devices may include a display, a printer, a fax machine, or non-visual displays such as audio output devices, or mobile devices. The displays may include a cathode ray tube (CRT), a flat-panel device such as a liquid crystal display (LCD), a projection device, or some mechanism for creating a visible image. The representation may also provide non-visual display such as via audio output devices. One or more augmented attributes from the database may be sent to vendors such as weather systems, mapping services, television networks. In some implementations the one or more augmented attributes may be sent to the vendor in electronic format. For example, the augmented database may be sent as an electronic database to a vendor for the vendor to thereby augment or create its own weather database. Additionally, in some implementations the augmented database can be sent to vendors whereby the vendors augment or create a display, including weather maps. Further, one or more augmented attributes from the database may also be sent as feeds into social networking platforms. Additionally, the maps may be drawings or simply a written or audio description of the affected geographic area. These maps may be available to end-users in either electronic form, for example by way of email, specialized web pages, or mobile applications, or by written or typed document. Clients and a variety of end users interact with the central command 120 through the client computing devices 140. The client computing devices 140 include memory for storage of data and software applications, a processor for accessing data and executing applications, and components that facilitate communication over the network in the process environment 100. The computing devices 140 execute applications, such as web browsers 150, that allow clients to interact with the visual displays and other information provided by the central command 120.

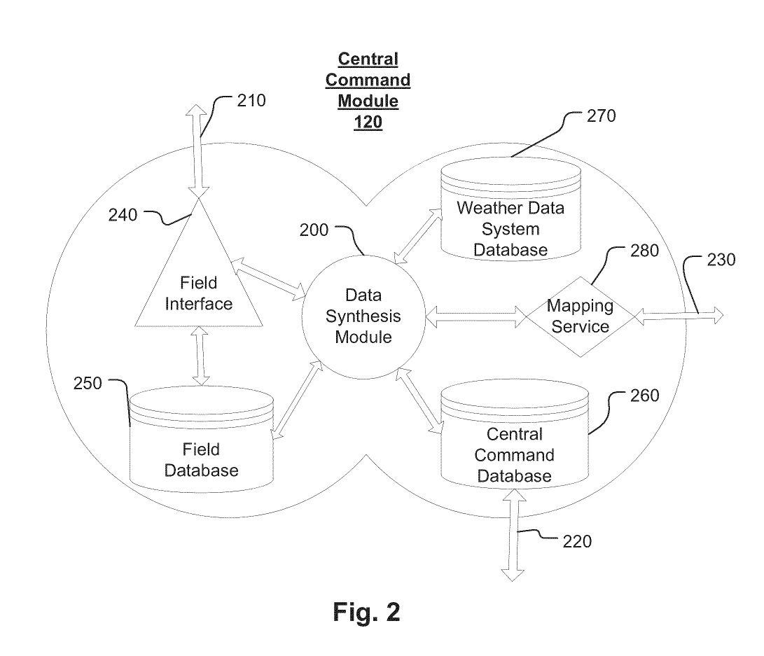

FIG. 2 illustrates a block diagram of an example central command module 120. The unidirectional and bidirectional arrows are merely representative of this particular example. Different directions may be used in different implementations. The central command module 120 comprises a data synthesis module 200 that may operate as a nerve center of all operations. The central command 120 may have one or more external communication networks. In this example, field network 210 communicates with remote sensing devices and devices operated by field personnel to input field data 110. Disaster management network 220 communicates with one or more weather data systems 130 to receive real-time data related to the disaster. Client service network 230 communicates with one or more client devices 140.

The weather data system database 270 is configured to receive and process initial attributes, including weather data received from one or more sources. This data may be directly or indirectly transferred, processed, and stored in the central command database 260. The field database 250 is configured to receive and process field data received from one or more field input sources. This data may be directly or indirectly transferred, processed, and stored in the central command database 260. The central command database maintains data on present and past disasters and the responses to those disasters. The weather data system database 270, the field database 250, and the central command database 260 are all in communication with the data synthesis module 200. The data synthesis module 200 receives processes and synthesizes the data from all three databases and creates one or more representations of the data. The particular representation depends on the type of client and the degree of detail that is required by the particular client. In some implementations, the data representation may take the form of an interactive map which is created and updated by the mapping service 280. The mapping service 280 is in communication with the data synthesis module 200. As real-time data pours in from the field and the weather stations, this data is synthesized by the data synthesis module 200, stored in the central command database 260 and relayed to mapping service 280 to update the interactive visual displays.

The field data may comprise data from field personnel deployed in the target geographic area or data captured through one or more social media platforms. The at least one source providing the field data may be a field personnel. Communication may include communication using a mobile device. In some implementations, the data synthesis module 200 may prompt the field interface 240 to send signals to field agents and remote sensing devices near the affected area requesting specific data. In some implementations, the central command module 120 may receive queries from the client devices 140 over the network 230, and execute the queries against the central command database 260 against the available documents such as web pages, images, text documents and multimedia content. The data synthesis module 200 identifies content that matches the queries, and responds by signaling the mapping service 280 to generate interactive displays, tags, menus, icons, and other means that are then transmitted to the client devices 140 in a form that can be presented to the clients.

The central command database 260 may include log files of data regarding client queries, documents viewed, weather data, past responses to weather, field data inputs, data field created by field personnel, etc. The log files may further include time stamp data and session id data that facilitate grouping of documents and other multimedia data.

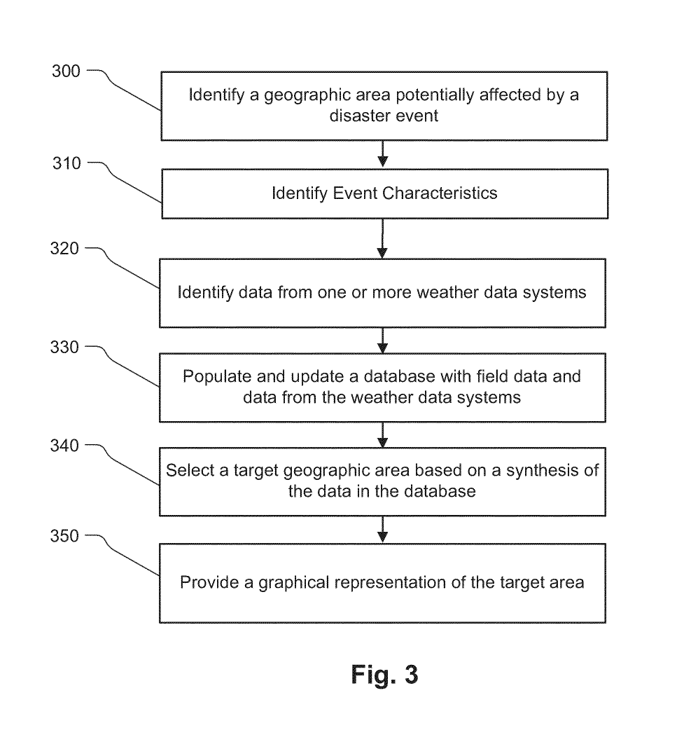

FIG. 3 illustrates a flow diagram of an example process that includes a feed from a weather data system. For convenience, the method 300-350 will be described with respect to a system that performs at least parts of the method. At step 300, the central command module 120 may receive data from one or more weather data systems 130 or other independent sources that indicate an imminent or recent disaster. A disaster event may include a weather related event (thunderstorm, tornado, snowstorm, hailstorm, lightning, drought, fires), a natural disaster event (earthquake, tsunami, floods, volcanoes), and/or a human induced event (wars, fires). The data synthesis module 200 identifies a potential geographic area that may be affected by the disaster event.

At step 310, the process identifies a set of event characteristics. These characteristics may be identified based on data from the weather data system 130 or from prior saved data stored in the central command database 270. These characteristics may also be identified based on field deployment. Field deployment can include manual deployment of personnel to document event characteristics, or field data collection through remote techniques, including aerial photographs, use of cartographic cameras, and/or satellite images.

The event characteristics pertaining to a disaster event generally depend on the disaster itself. These are characteristics pertaining to the prevalent weather conditions, and specific conditions related to the type of physical damage. Event characteristics may include photographs of the damage, sampling of field data pertaining to the size, spread and magnitude of impact characteristics, geo-position markers for event impact areas, real-time reading of humidity, pressure, temperature, wind velocity, water level, etc. For instance, flooding can often be the cause of basement wall, foundation and retaining wall failure. Special techniques using various camera technologies like infrared thermography may be used to accurately collect pertinent field data that may then enable damage assessment.

Most parts of the United States are susceptible to hail, and there is an average of 3,000 hailstorms a year. During a hailstorm, event characteristics would include descriptors that include the size of hail, the duration of a hailstorm, and wind direction, and these descriptors may then be correlated to the type and extent of damage to a roof based on logs of past disaster response and recovery efforts. This assessment may additionally factor in the type of roofing and the kind of shingle used. Similarly, hail damage to an HVAC unit may be assessed by certified forensic technicians who evaluate the unit on-site, upload the field data, and provide additional texturing to the map.

During ice storms, physical damage may be caused by fire from downed power lines, or damage to physical property from fallen trees or tree limbs, or acute damage as a result of ice damming. Heavy rain from tropical storms or a thunderstorm may cause problems around a home or commercial structure. Rain-related problems include water leaking into the framing of the roof and soil saturation. Roof systems may be damaged by snow, when excessive snow accumulates on the roofing structure. Steel-framed structures may also be damaged by excessive snowing that causes loads to exceed the expected loading.

Lightning causes estimated losses of over $5 billion per year within the United States alone. Predetermined event characteristics may be used by forensic engineers to determine whether the reported damage is due to lightning or not, and also to determine the geographic area likely to have been impacted by a lightning strike. In each such instance, different event characteristics tailored to the specific type of disaster event would need to be collected and uploaded into the database.

At step 320, the process identifies data from one or more weather data systems 130. These may include feeds pertaining to meteorological data indicative of a weather phenomenon. In particular, the weather data system 130 could be received from a source such as NEXRAD weather data provided by the National Weather Service. Such data may also be received directly from a real-time weather source such as a doppler or pulse-doppler weather data system managed by a television or cable network. Many weather display systems are configured to communicate and message real-time with a communication and monitoring process environment 100 as disclosed herein.

At step 330, the data synthesis module 200, in conjunction with the central command database 260, the field database 250 and the weather data system database 270, populates and updates a database with field data 110 and data from the weather data system 130. In some implementations, an interim graphical or visual representation of this data is formed by the mapping service 280. This interim representation of data may be conveyed to one or more client devices 140 as a real-time, dynamic and interactive map. In some implementations, the data synthesis module 200 maintains bidirectional communication networks comprising the field network 210 which communicates with remote sensing devices and devices operated by field personnel to input field data 110; the disaster management network 220 which communicates with one or more weather data systems 130 to receive real-time data related to the disaster; and the client service network 230 which communicates with one or more client devices 140. These communication networks may be completely or partially manual or automated. These networks communicate with the field devices, client devices and disaster management fields to further enhance the quality and understanding of the data received, thereby updating the real-time, dynamic and interactive map.

At step 340, the communication and monitoring process environment 100 synthesizes the data received and forms the map of a target geographic area. This step is of particular use in certain industries, for example, the insurance industry. Storms cause physical damage to various properties. In order to efficiently validate and process property damage claims, insurance companies, state and federal agencies, and/or other organizations, need to verify both the geographical boundary of the affected area, and the type and extent of damage to individual properties within the area. The volume of post event claims is typically high. This makes it near impossible for insurance companies to send field agents to verify each claim. An embodiment of the present invention is directed at providing dependable, verifiable, and accurate real-time field data that has been correlated to real-time data feed from a weather data system and synthesized to create a true mapping of the area affected by the disaster and the extent and type of damage that has been inflicted upon that area. In some implementations, the representation of the one or more augmented attributes may include representation on a display device. In some implementations, this representation may be in the form of a real-time mapping of the affected area. In some implementations, such a map may be an interactive display with icons and menus that are capable of providing further data, and/or provide access to location specific images, audio, video, and related documents. The representation may also provide non-visual display such as via audio output devices. One or more augmented attributes from the database may be sent to vendors such as weather systems, mapping services, or television networks. In some implementations the one or more augmented attributes may be sent to the vendor in electronic format. For example, the augmented database may be sent as an electronic database to a vendor for the vendor to thereby augment or create its own weather database. Additionally, in some implementations the augmented database can be sent to vendors whereby the vendors augment or create a display, including weather maps. Further, one or more augmented attributes from the database may also be sent as feeds into social networking platforms. Additionally, the maps may be drawings or simply a written or audio description of the affected geographic area. These maps may be available to end-users in either electronic form, for example by way of email, specialized web pages, or mobile applications, or by written or typed document. As is well known in the art, a typed document may include a computer printed report and/or an electronic report (e.g., in portable document format).

For instance, an augmented map that represents the target geographic area affected by the disaster related event may be prepared. An initial map of a target area morphs into an augmented map representing the scope and dimension of the disaster. The details in the augmented map may be further enhanced to provide collateral indicators to determine if a claim was a result of a disaster event or another cause. The insurance company uses this data to validate insurance claims, and saves its time and resources to individually pursue claims that fall outside the reported damage area, or fall at or close to the boundary of the reported damage area. This substantially reduces the strains on the insurer's financial and human resources, while also ensuring a fast, reliable and efficient mechanism for the insured individual to have their legitimate claims authorized by the insurance company.

Field input sources that communicate over communication network 210 may include a keyboard, pointing devices such as a mouse, trackball, touchpad, or graphics tablet, a scanner, a touch screen incorporated into the display, audio input devices such as voice recognition systems, microphones, and other types of input devices. In general, use of the term “input device” is intended to include all possible types of devices and ways to input information into central command module 120.

At step 350, the central command module 120 produces some user friendly representation of the disaster related data. In some implementations, a mapping service 280 within the central command module 120 may create specialized maps that may be interactive, offering different levels of detail, 2-D, 3-D or satellite views, populated with positional icons with field data, and/or contour mapping. Additionally, the maps may be drawings or simply a written or audio description of the affected geographic area. These maps may be available to end-users in either electronic form, for example by way of email, specialized web pages, or mobile applications, or by written or typed document.

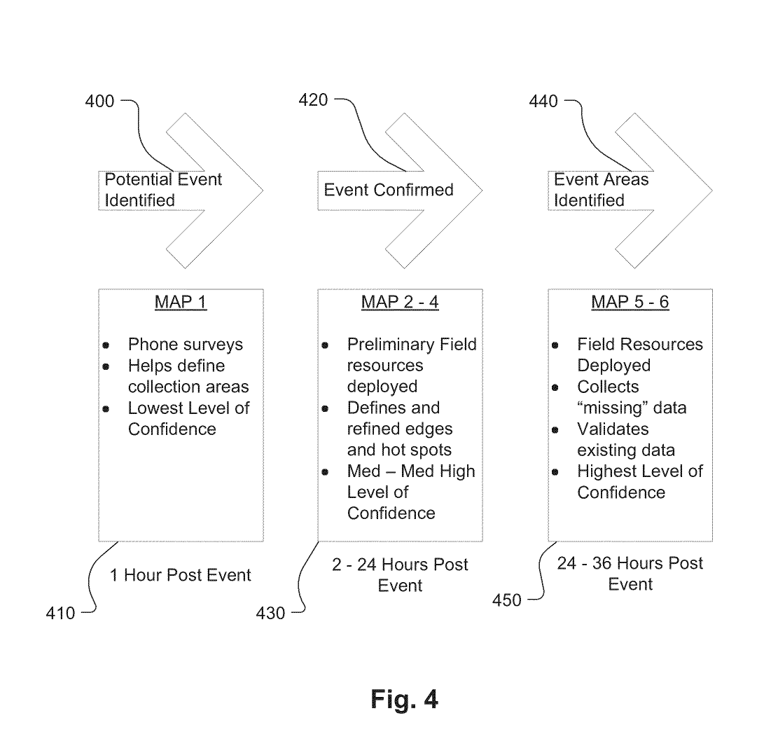

FIG. 4 illustrates a block diagram of an example post event periodic retrieval and update process of the disclosed system and method. In many instances, after a particular disaster event occurs, the landscape of damage and recovery may not be immediately ascertainable. This may be due to a variety of reasons, including the lack of physical access to the affected area. In such situations, the process environment 100 acts iteratively by taking snapshots of available data at pre-determined post-event time intervals. The data synthesis module 200, in conjunction with the central command database 270, the field database 250 and the weather data system database 260, populates and updates a database with field data 110 and data from the weather data system 130 at these predetermined time intervals. In some implementations, an interim graphical or visual representation of this data is formed by the mapping service 280.

In one implementation, at step 400, an hour after a potential disaster related event, the process environment 100 identifies the event. A first interactive map 410 is created based on initial field surveys. This first interactive map 410 may be considered to have the lowest level of confidence, but it helps define the geographical areas in which further detailed information is needed.

At step 420, during a time interval of 2 to 24 hours after the reported event, the event is confirmed. The next few iterations of the interactive map are formed; for instance iterations 2 through 4 are shown at step 430. These maps show the field data collected which defines and refines the edges and hot spots of the affected area. These iterations may be considered to have some more real-time data and are considered to have medium to medium high level of confidence.

Finally, at step 440, during a time interval of 24 to 36 hours after the reported event, sufficient data is collected and synthesized to form a final boundary of the event area. At step 450, the final interactive map shows the field resources, identifies any missing field data that may need to be collected, and validates existing data against feeds from the weather data systems and the field data. This iteration of the interactive map is considered to have the highest level of confidence.

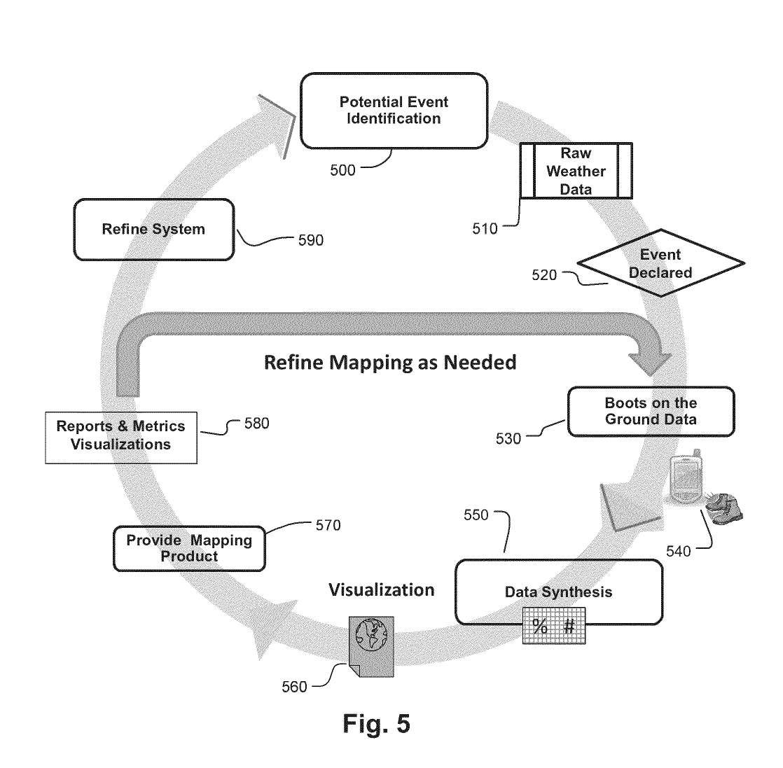

FIG. 5 illustrates a block diagram of an example communication and monitoring process environment. At step 500, a potential event is identified. At step 510, raw weather data is received. For instance, the central command module 120 may receive raw weather data from one or more weather data systems 130 or other independent sources that indicate an imminent or recent disaster. These may include feeds pertaining to meteorological data indicative of a weather phenomenon. In particular, the weather data system 130 could be received from a source such as NEXRAD weather data provided by the National Weather Service. Such data may also be received directly from a real-time weather source such as a doppler or pulse-doppler weather data system managed by a television or cable network. Many weather display systems are configured to communicate and message real-time with a communication and monitoring process environment 100 as disclosed herein. A disaster event may include a weather related event (thunderstorm, tornado, snowstorm, hailstorm, lightning, drought, fires), a natural disaster event (earthquake, tsunami, floods, volcanoes), and/or a human induced event (wars, fires). The data synthesis module 200 identifies a potential geographic area that may be affected by the disaster event and at step 520 an event is declared to have occurred.

At step 530, event characteristics may be identified based on data from the weather data system 130 or from prior saved data stored in the central command database 270. These characteristics may also be identified based on field deployment. Field deployment can include manual deployment of personnel to document event characteristics, or field data collection through remote techniques, including aerial photographs, use of cartographic cameras, and/or satellite images. Field input sources 540 that communicate over communication network 210 may include a keyboard, pointing devices such as a mouse, trackball, touchpad, or graphics tablet, a scanner, a touch screen incorporated into the display, audio input devices such as voice recognition systems, microphones, and other types of input devices. In general, use of the term “input device” is intended to include all possible types of devices and ways to input information into central command module 120.

At step 550 the data synthesis module 200, in conjunction with the central command database 270, the field database 250 and the weather data system database 260, populates and updates a database with field data 110 and data from the weather data system 130. The field data may comprise data from field personnel deployed in the target geographic area or data captured through one or more social media platforms. The at least one source providing the field data may be a field personnel. Communication may include communication using a mobile device. In some implementations, the database may be updated with field data including automated receipt and update of data, including data from field deployed remote sensors, cartographic cameras, aerial reconnaissance systems, or satellite images. In yet other implementations, the updating of the database with the field data may include iterative updating of the database at pre-determined time intervals.

In some implementations, an interim augmentation such as a preliminary graphical or visual representation 560 of this data may be formed. This interim representation of data may be conveyed to one or more client devices as a real-time, dynamic and interactive map. In some implementations, the data synthesis module maintains bidirectional communication networks comprising the field network which communicates with remote sensing devices and devices operated by field personnel to input field data; the disaster management network which communicates with one or more weather data systems to receive real-time data related to the disaster; and the client service network which communicates with one or more client devices. These communication networks may be completely or partially manual or automated. These networks communicate with the field devices, client devices and disaster management fields to further enhance the quality and understanding of the data received, thereby updating the real-time, dynamic and interactive map. Communication may include communication using a mobile device and/or be conducted over cloud servers.

At step 570, the communication and monitoring process environment 100 synthesizes the data received and transforms the initial attributes received into one or more augmented attributes. In some implementations, the environment 100 may form the map of a target geographic area to provide a mapping product such as an augmented map. The map itself may be tagged, annotated and/or accompanied by menus, icons, photographs, text, and audio, related to the disaster event. At step 580 reports and metric visualizations are created that may require further input from field devices 540. Steps 530-580 may be repeated iteratively to refine the mapping product 570. At step 590, the system that controls the process environment may also be refined through the iterative process.

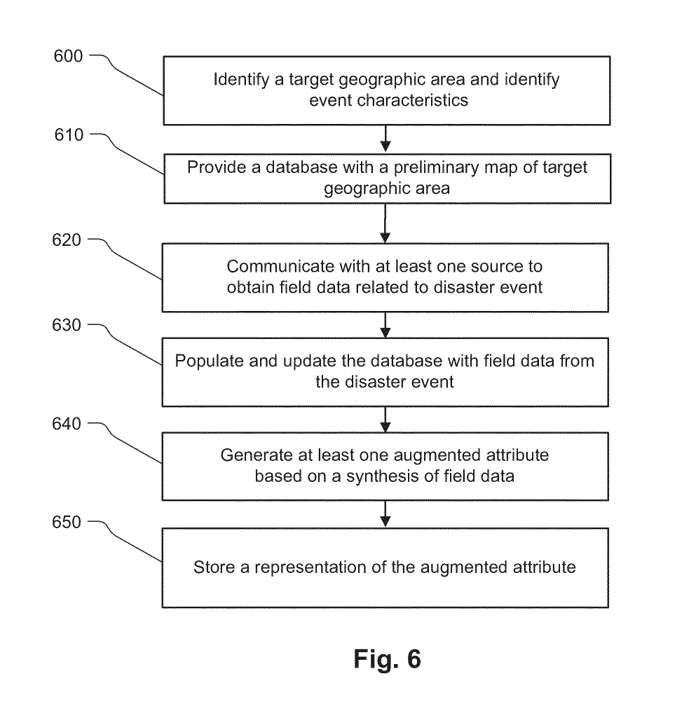

FIG. 6 illustrates a flow diagram of an example process that may not include a feed from a weather data system. For convenience, the method 600-650 will be described with respect to a system that performs at least parts of the method, and this example will be further described in relation to the disaster event being a hailstorm. At step 600, the system described herein may receive data from one or more sources that indicate an imminent or recent disaster. Such sources may include feeds from weather systems, or cable and/or television networks, or may include preliminary reports from field agents, individuals, and/or first response teams in the affected area. A potential geographic area that may be affected by the disaster event is identified and a set of event characteristics pertaining to the particular event are also identified.

For instance, when the disaster event is a hailstorm, initial reports may be received from individuals in the affected area, or from a television report, or a doppler or pulse-doppler weather system. A target geographic area is then determined. Typical event characteristics may include descriptors that include the size of hail, damage to property, the duration of a hailstorm, and wind direction. These descriptors may already be in the system database and may be presented to field personnel in on or more preset data entry fields.

At step 610, the system creates a preliminary map of the targeted geographic area. This may include some initial data regarding the type, degree and scope of the disaster event. In some implementations, this step may also include obtaining initial data from one or more independent clients, individuals and/or vendors that verifies that a disaster event has indeed occurred. Such verification may involve a phone verification system by an independent vendor wherein telephone calls are made to residents in the target area to map out an initial target area. The preliminary map may also be obtained using a satellite image of the targeted area.

At step 620, the system communicates with at least one source to obtain field data related to the disaster event. This field data may include responses to system prompts regarding predetermined event characteristics. This step may also involve data entry into new or existing data fields by field personnel. The data itself may be in the form of interviews, photographs, text, and other descriptors pertaining to the disaster event. In the case of a hailstorm, the field data may record the different sizes of the hail in different parts of the target geographic area, the duration of the hailstorm, a time-dependent vector field describing the wind velocities, or the types of damage within the geographic area. For example, in certain parts within the geographic area, the resultant damage could be to the roof systems, and in certain other parts, the resultant damage could be to HVAC systems. In yet other parts, the damage could be to the walls of the residential or commercial property. Additionally, the degree and extent of damage inflicted in different parts of the targeted geographic area may vary depending on the size of the hail, the duration of the hailstorm, and the wind velocity. Field data collected will be customized to account for these varying factors.

At step 630, the database is populated and updated with the field data. This process may be at least partially automated. As the data comes in, the system may prompt one or more field personnel for more data, or remotely configure remote sensing devices to gather more localized data. In some implementations, an interim or preliminary graphical or visual representation of this data may be implemented by a mapping service. This interim representation of data may be conveyed to one or more client devices as a real-time, dynamic and interactive map.

At step 640, the system generates at least one augmented attribute of the target area based on a synthesis of the field data in the database. In some implementations, the system synthesizes the data received and forms the map of a target geographic area. In some implementations, the system maintains bidirectional communication networks comprising the field network which communicates with remote sensing devices and devices operated by field personnel to input field data and the client service network which communicates with one or more client devices. These communication networks may be completely or partially manual or automated. These networks communicate with the one or more field devices and client devices to further enhance the quality and understanding of the data received, thereby refining the real-time, dynamic and interactive map. The field data is further used to authenticate or dismiss the initial data and reports received. As more verifiable field data is fed into the system, a clearer picture of the damage begins to emerge.

For instance, in the event of a hailstorm, data related to the size of the hailstorm is initially received and an initial attribute, such as a contour map of the target region may be formed based upon the sizes of the hail reported. These initial reports are then verified by actual measurements by field personnel. The field data may also include photographs of the damage caused by the hail. As more data is received, an augmented map is formed, which may, in one implementation, be a contour map that describes the target geographic region in terms of hail size. A given contour represents parts of the region that were impacted by hail of a given size. This contour map may then be overlaid by data representing vectors of wind velocity. The extent of damage to a roof may be estimated from these factors based on predetermined conditions correlating the damage to the event characteristics. In some implementations, the system may be programmed to make such predictive analysis. A mapping service may then augment the map of the geographic region depending upon the likelihood of damage, its type and extent.

At step 650, the system stores a representation of the at least one augmented attribute. In some implementations, an augmented map may be stored and may be optionally delivered onto a client device. Such a device may include mobile devices, desktop devices, or a combination of both. The details in the augmented map provide collateral indicators to determine if a claim was a result of a disaster event or another cause. For instance, in some implementations, the augmented map may be subdivided into grids, wherein each individual grid may be considered to be within the affected area, outside the affected area, or fall within an ambiguous region where individual properties would need to be further analyzed to obtain an accurate picture. The insurance company uses this data to validate insurance claims for properties that fall within the affected area, and dismiss claims that fall outside the affected area. It may choose to individually pursue claims from properties that are in the ambiguous region of the target area. This substantially reduces the strains on the insurer's financial and human resources, while also ensuring a fast, reliable and efficient mechanism for the insured individual to have their legitimate claims authorized by the insurance company.

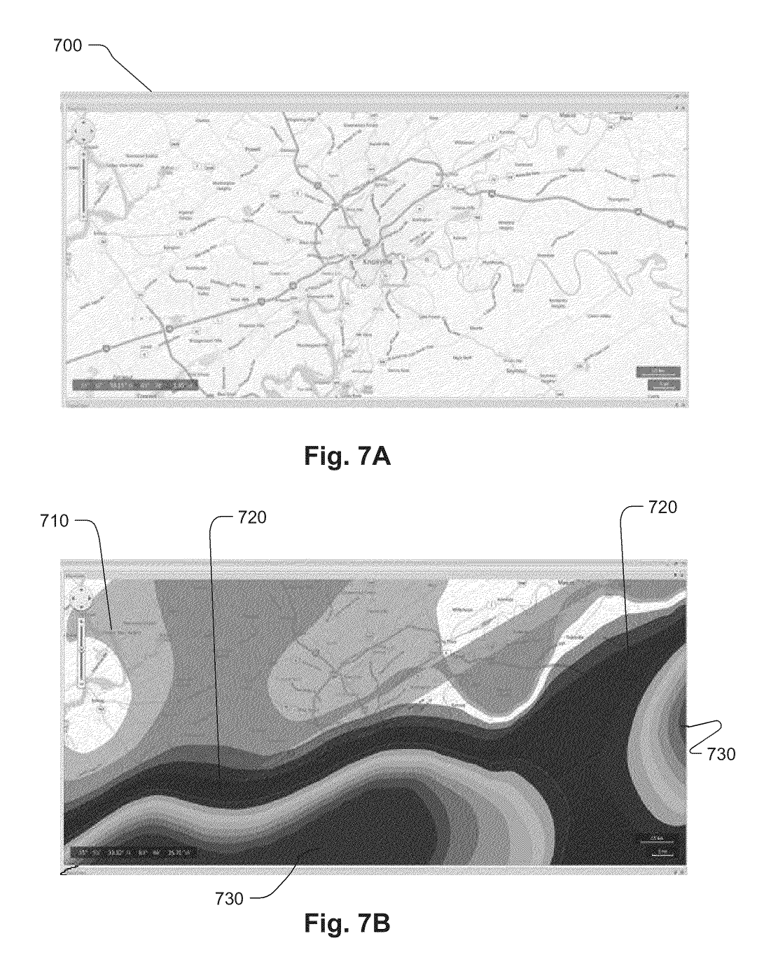

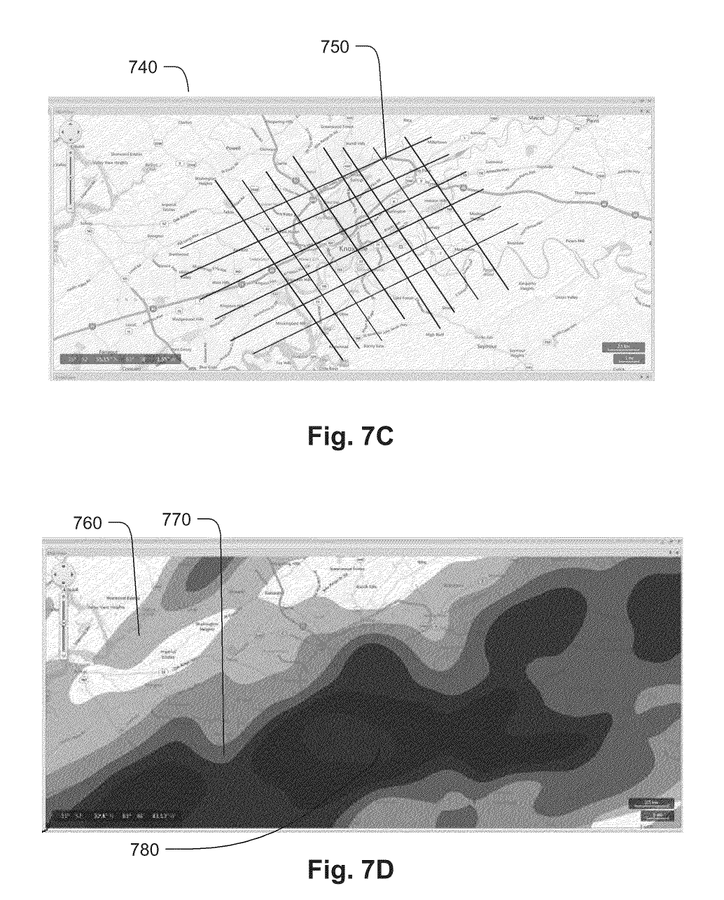

In general, one aspect of the technology described can be embodied in methods that include identifying a target geographic area potentially affected by a disaster event, and identifying event characteristics. The method further includes providing a database with at least one initial attribute of the target area. The method further includes communicating with at least one source to obtain field data related to the disaster event, and updating the database with the field data. The method further includes generating at least one augmented attribute of the target area based on a synthesis of the field data in the database. A representation of the at least one augmented attribute is then stored. FIGS. 7A-D illustrate one implementation of the method.

The disaster event may be a weather-related event comprising a thunderstorm, tornado, snowstorm, hailstorm, lightning, drought, or fire. FIG. 7A illustrates an example map based on a feed from a weather data system indicating a hailstorm in a geographic area. A large geographic region 700 is identified based on information received from a weather data system such as a feed from a disaster management system, a television signal, a doppler or pulse-doppler radar signal, or feeds from one or more social media platforms such as Facebook, twitter, etc. The feeds indicate a large hailstorm that encompasses a large area.

FIG. 7B illustrates an example of an initial attribute in the form of a contoured map representing projected hailstone sizes. Predicted hailstone sizes are identified on a contoured map. The region 710 corresponds to the smallest sized hail stone; region 720 corresponds to intermediate sized hail stone, whereas the regions 730 correspond to the largest sized hail stone. The entire identified geographic region 700 is thus initially attributed with initial data from a weather feed.

FIG. 7C illustrates an example of a map representing a data collection grid to capture event characteristics. Event characteristics may comprise factors such as the average size of the hail, the affected geographical area, the time length of the storm, the typical size of hail impact, the damage to property, or the wind velocities. A strategy is developed to collect event characteristics from the field. A preliminary map 740 indicates a data collection grid 750 that divides a portion of the geographic area and identifies it as the region from where field data will be collected. The preliminary map and the data collection grid are further examples of an initial attribute.

The field data may comprise data from field personnel deployed in the target geographic area or data captured through one or more social media platforms. The at least one source providing the field data may be a field personnel. Communication may include communication using a mobile device. In some implementations, the database may be updated with field data including automated receipt and update of data, including data from field deployed remote sensors, cartographic cameras, aerial reconnaissance systems, or satellite images. In yet other implementations, the updating of the database with the field data may include iterative updating of the database at pre-determined time intervals.

FIG. 7D illustrates an example of an augmented attribute. In this example, it is a contoured map representing actual hailstone sizes based on field data. In the figure, region 760 corresponds to the smallest sized hail stones, region 770 corresponds to intermediate sized hail stones, whereas region 780 corresponds to the largest sized hail stones. A comparison of the initial attribute in FIG. 7B and the augmented attribute in FIG. 7D clearly indicates how the field data informs and modifies the initial data obtained from the weather feeds. For instance, a region 730 projected to receive large hail stones actually received intermediate sized hailstones. Similarly, region 730, projected to receive large hailstones, morphs into a considerably smaller region 780.

In some implementations, the representation of the augmented attribute may be a visual representation, and in some implementations, the visual representation may include a map of the target geographic area. In some implementations, the at least one initial attribute may include an initial map of the target geographic area. The visual representation may include an augmented map of the target geographic area based on the event characteristics. In some implementations, the at least one target geographic area may be obtained from a weather data system. In some implementations, the at least one target geographic area may be obtained from a social media platform.

In some implementations, the representation of the one or more augmented attributes may include representation on a display device. Field or client output devices may include a display, a printer, a fax machine, or non-visual displays such as audio output devices, or mobile devices. The displays may include a cathode ray tube (CRT), a flat-panel device such as a liquid crystal display (LCD), a projection device, or some mechanism for creating a visible image. The display may also provide non-visual display such as via audio output devices. One or more augmented attributes from the database may be sent to vendors such as weather systems, mapping services, or television networks. In some implementations the one or more augmented attributes may be sent to the vendor in electronic format. For example, the augmented database may be sent as an electronic database to a vendor for the vendor to thereby augment or create its own weather database. Additionally, in some implementations the augmented database can be sent to vendors whereby the vendors augment or create a display, including weather maps. Further, one or more augmented attributes from the database may also be sent as feeds into social networking platforms. Additionally, the maps may be drawings or simply a written or audio description of the affected geographic area. These maps may be available to end-users in either electronic form, for example by way of email, specialized web pages, or mobile applications, or by written or typed document. In general, use of the term “output device” is intended to include all possible types of devices and ways to output information from central command module 120 to the field personnel, client or to another machine or computer system.

It is understood that these examples are intended in an illustrative rather than in a limiting sense. Computer-assisted processing is implicated in the described embodiments. It is contemplated that modifications and combinations will readily occur, which modifications and combinations will be within the scope of the following claims.

What is claimed is:

1. A computer implemented method, comprising:
identifying an interactive map of a geographic area potentially affected by an event;
identifying at least one event characteristic associated with the event, the at least one event characteristic based on field data from the geographic area;
identifying one or more objects in the geographic area;
providing a selectable option for selection of at least one attribute, the at least one attribute including one or more of:
the at least one event characteristic,
at least one damage characteristic associated with a given object of the one or more objects, the at least one damage characteristic identifying potential damage to the given object based on the event,
a damage likelihood associated with the given object, the damage likelihood indicative of a probability of damage to the given object based on the event,
a level of confidence associated with the at least one event characteristic, the level of confidence indicative of confirmation of the field data;
identifying a selection of the at least one attribute; and
providing, in response to the selection of the at least one attribute, the selected at least one attribute with the interactive map.

2. The method of claim 1, wherein identifying the interactive map includes retrieving, via a computer network, the interactive map from a database.

3. The method of claim 1, wherein providing the selected at least one attribute includes retrieving, via a computer network, the selected at least one attribute from a database.

4. The method of claim 1, wherein providing the selected at least one attribute includes texturing the interactive map with the selected at least one attribute.

5. The method of claim 1, wherein the at least one damage characteristic is based on the at least one event characteristic.

6. The method of claim 1, wherein the at least one attribute further includes data related to the one or more objects.

7. The method of claim 6, wherein the data related to the one or more objects is based on one or more of a photograph, text, video, and audio related to the event.

8. The method of claim 1, wherein the event is a hail storm and the at least one damage characteristic is roof damage assessment based on a range of hail sizes.

9. The method of claim 1, wherein the event is high wind and the at least one damage characteristic is roof damage assessment based on one or more of wind direction and wind speed.

10. The method of claim 1, wherein the at least one attribute further includes at least one initial attribute based on data from a weather data system.

11. The method of claim 10, wherein the event is a hail storm, and the initial attribute is a distribution of hail sizes based on data from the weather data system.

12. The method of claim 10, further including providing a comparison of the initial attribute and the at least one event characteristic.

13. The method of claim 1, wherein the event is a hail storm, and the at least one event characteristic is a distribution of hail sizes based on the field data.

14. The method of claim 1, wherein the level of confidence is based on one or more of the event, geographic area, strength of field data, and length of elapsed time after the event.

15. The method of claim 1, wherein providing the selected at least one attribute includes displaying the selected at least one attribute as a contour map.

16. The method of claim 1, wherein the selectable option for the selection of the at least one attribute includes an option to select a time period.

17. The method of claim 1, wherein identifying the selection of the at least one attribute includes receiving a query related to the at least one attribute.

18. The method of claim 17, wherein receiving the query related to the at least one attribute includes identifying a selection of a portion of the interactive map.

19. The method of claim 18, wherein the selection of the portion of the interactive map includes one or more of a mouse click, a click-through, an audio selection, and a selection by a user's finger on a touch-sensitive input device.

20. The method of claim 1, wherein the at least one attribute is an interactive graphic attribute.

21. The method of claim 1, wherein the interactive map of the geographic area includes image data from one or more of a satellite and an aerial vehicle.

22. The method of claim 21, wherein the image data includes one or more of a photograph and a video.

23. The method of claim 1, wherein the event includes one or more of a thunderstorm, rain, tornado, snowstorm, hailstorm, lightning, drought, wind, fire, earthquake, tsunami, flood, volcano, and war.

24. The method of claim 1, wherein the field data includes data from one or more of field surveys and field personnel deployed in the geographic area.

25. The method of claim 1, further including providing a report based on the at least one attribute.

26. The method of claim 1, wherein said geographic area is based on one or more of the event and a time period.

27. The method of claim 1, wherein providing the selected at least one attribute includes displaying the selected at least one attribute on a computing device.

28. The method of claim 27, wherein the computing device is a mobile computing device.

29. The method of claim 1, wherein the selectable option for selection of the at least one attribute includes one or more of a menu and an icon.

30. The method of claim 1, further including:
subdividing the geographic area into one or more grids; and
associating a given grid of the one or more grids with a given attribute of the at least one attribute.

31. A system including memory and one or more processors operable to execute instructions stored in the memory, comprising instructions to:
identify an interactive map of a geographic area potentially affected by an event;
identify at least one event characteristic associated with the event, the at least one event characteristic based on field data from the geographic area;
identify one or more objects in the geographic area;
provide a selectable option for selection of at least one attribute, the at least one attribute including one or more of:
the at least one event characteristic,
at least one damage characteristic associated with a given object of the one or more objects, the at least one damage characteristic identifying potential damage to the given object based on the event,
a damage likelihood associated with a given object of the one or more objects, the damage likelihood indicative of a probability of damage to the given object,
a level of confidence associated with the at least one event characteristic, the level of confidence indicative of confirmation of the field data;
identify a selection of the at least one attribute; and
provide, in response to the selection of the at least one attribute, the selected at least one attribute with the interactive map.

32. The system of claim 31, wherein the instructions to identify the interactive map include instructions to retrieve the interactive map from a database.

33. The system of claim 31, wherein the instructions to provide the selected at least one attribute include instructions to retrieve the selected at least one attribute from a database.

34. The system of claim 31, wherein the instructions to provide the selected at least one attribute include instructions to texture the interactive map with the selected at least one attribute.

35. The system of claim 31, wherein the at least one damage characteristic is based on the at least one event characteristic.

36. The system of claim 31, wherein the at least one attribute further includes data related to the one or more objects.

37. The system of claim 36, wherein the data related to the one or more objects is based on one or more of photograph, text, video, and audio related to the event.

38. The system of claim 31, wherein the event is a hail storm and the at least one damage characteristic is roof damage assessment based on a range of hail sizes.

39. The system of claim 31, wherein the event is high wind and the at least one damage characteristic is roof damage assessment based on one or more of wind direction and wind speed.

40. The system of claim 31, wherein the at least one attribute further includes at least one initial attribute based on data from a weather data system.

41. The system of claim 40, wherein the event is a hail storm, and the initial attribute is a distribution of hail sizes based on data from the weather data system.

42. The system of claim 40, further including instructions to provide a comparison of the initial attribute and the at least one event characteristic.

43. The system of claim 31, wherein the event is a hail storm, and the at least one event characteristic is a distribution of hail sizes based on the field data.

44. The system of claim 31, wherein the level of confidence is based on one or more of the event, geographic area, strength of field data, and length of elapsed time after the event.

45. The system of claim 31, wherein the instructions to provide the selected at least one attribute includes instructions to display the at least one attribute as a contour map.

46. The system of claim 31, wherein the selectable option for the selection of the at least one attribute includes an option to select a time period.

47. The system of claim 31, wherein instructions to identify the selection of the at least one attribute includes instructions to receive a query related to the at least one attribute.

48. The system of claim 47, wherein the instructions to receive the query related to the at least one attribute includes instructions to identify a selection of a portion of the interactive map.

49. The system of claim 48, wherein the selection of the portion of the interactive map includes one or more of a mouse click, a click-through, an audio selection, and a selection by a user's finger on a touch-sensitive input device.

50. The system of claim 31, wherein the at least one attribute is an interactive graphic attribute.

51. The system of claim 31, wherein the interactive map of the target geographic area includes image data from one or more of a satellite and an aerial vehicle.

52. The system of claim 51, wherein the image data includes one or more of a photograph and a video.

53. The system of claim 31, wherein the event includes one or more of a thunderstorm, rain, tornado, snowstorm, hailstorm, lightning, drought, wind, fire, earthquake, tsunami, flood, volcano, and war.

54. The system of claim 31, wherein the field data includes data from one or more of field surveys and field personnel deployed in the target geographic area.

55. The system of claim 31, further including instructions to provide a report based on the at least one attribute.

56. The system of claim 31, wherein said geographic area is based on one or more of the event and a time period.

57. The system of claim 31, wherein the instructions to provide the selected at least one attribute include instructions to display the selected at least one attribute on a computing device.

58. The system of claim 57, wherein the computing device is a mobile computing device.

59. The system of claim 31, wherein the selectable option for selection of the at least one attribute includes one or more of a menu and an icon.

60. The system of claim 31, further including instructions to:
subdivide the geographic area into one or more grids; and
associate a given grid of the one or more grids with a given attribute of the at least one attribute.

61. A non-transitory computer readable storage medium storing computer instructions executable by a processor to perform a method comprising:
identifying an interactive map of a geographic area potentially affected by an event;
identifying at least one event characteristic associated with the event, the at least one event characteristic based on field data from the geographic area;
identifying one or more objects in the geographic area;
providing a selectable option for selection of at least one attribute, the at least one attribute including one or more of:
the at least one event characteristic,
at least one damage characteristic associated with a given object of the one or more objects, the at least one damage characteristic identifying potential damage to the given object based on the event,
a damage likelihood associated with a given object of the one or more objects, the damage likelihood indicative of a probability of damage to the given object,
a level of confidence associated with the at least one event characteristic, the level of confidence indicative of confirmation of the field data;
identifying a selection of the at least one attribute; and
providing, in response to the selection of the at least one attribute, the selected at least one attribute with the interactive map.
